(19) United States
(12) Patent Application Publication
(10) Pub. No.: US 2009/0265560 A1
(43) Pub. Date: Oct. 22, 2009

(54) Numbering Method, Numbering Device, and Laser Direct Drawing Apparatus

(75) Inventors: Teppei Oguni, Atsugi (JP); Naoaki Tsutsui, Atsugi (JP); Tatsuji Nishijima, Atsugi (JP)

Correspondence Address: Cook Alex Ltd., SUITE 2850, 200 WEST ADAMS STREET, CHICAGO, IL, 60606, US

(73) Assignee: Semiconductor Energy Laboratory Co., Ltd.

(21) Appl. No.: 12/405,750

(22) Filed: Mar. 17, 2009

(30) Foreign Application Priority Data
Mar. 20, 2008 (JP) 2008-072632

(51) Int. Cl. G06F 21/00; H04L 9/28

(52) U.S. Cl. 713/185; 380/28

(57) ABSTRACT

An object is to give an identification number which is hard to guess from the previous and next identification numbers without overlap, to give an identification number by using a simple program, or to generate rapidly an identification number without using a memory medium having large capacitance. An integer obtained as a set of ciphertexts through bijective mapping from a set of integers which is a plaintext is used as an identification number. In specific, a set of integers without overlap is used as a plaintext space and encryption thereof is performed, so that an element of a ciphertext space obtained from the set of the plaintext space is used as an identification number. As the encryption, a bijective encryption method is employed; for example, RSA cryptosystem or ElGamal cryptosystem can be employed.

### BACKGROUND OF THE INVENTION

1. Field of the Invention

This invention relates to a numbering method which gives identification numbers to corporeal objects or incorporeal objects in order to identify them, a numbering device which gives an identification number by using the numbering method, and a laser direct drawing apparatus which uses the numbering device.

2. Description of the Related Art

The development in information technology in recent years has made a variety of systems widespread in society. One of the things which are indispensable in building any system is the identification number. Identification numbers are unique and given to systems as private marks in order to distinguish the components of the systems.

In general, the identification numbers need to be given to systems without overlap in all components in the systems even if the scale of the systems is large. For example, in a system utilizing RFID (radio frequency identification) technology which is rapidly getting widespread in recent years, media called RF tags, RF chips, IC chips, or the like in which integrated circuits and antennas are incorporated are used as components. In addition, standards of various RFID set up giving of identification numbers to each of RF tags, which do not overlap with each other.

Moreover, when a system is used by a plurality of users, aiming at security protection, prevention of unfair use, and the like, identification numbers are given to users who are allowed to use the system in order to distinguish the users from the others in some cases. In the case where identification numbers which allow use of the system are given, the identification numbers need to be not only unique so as not to overlap with each other but also hard to guess from the previous and next identification numbers in order to prevent use of the system with a forged identification number.

As a method for giving an identification number which is hard to guess, a method using pseudorandom numbers can be given. If a calculation method of the pseudorandom numbers cannot be specified, the pseudorandom number is hard to guess from the previous and next identification numbers. Therefore, by using the pseudorandom numbers, an identification number which is hard to guess can be given. A reference (Japanese Published Patent Application No. 2004-29984) discloses a numbering method using pseudorandom numbers.

### SUMMARY OF THE INVENTION

In order to enhance the certainty of the prevention of forged identification numbers, the total number of identification numbers to be given needs to be large and one identification number needs to be hard to guess from another identification number. In addition, in the case of the numbering method using pseudorandom numbers, an identification number which is newly given needs to be checked whether it does not overlap any identification number which is previously given. In other words, two programs for generating pseudorandom numbers and for checking whether an identification number generated do not overlap identification numbers previously generated are required. Further, in order to check whether there is no overlap in identification numbers, all identification numbers given need to be stored in a memory medium such as a hard disc, so that whether an identification number newly given and any of the identification numbers previously generated which are stored in the memory medium overlap each other or not is checked. For example, in the case where one hundred million identification numbers each of which has 32 bits (4 bytes) are stored in a hard disc without data compression, a capacitance of 4 bytes×100000000=400 MB is required in simple estimate of the required capacitance. If the hundred million identification numbers are already stored in the hard disc, in order to newly give only one identification number, the newly given number needs to be compared with data of 400 MB to check whether there is no overlap. Moreover, as the number of given identification numbers increases, the capacitance of the memory medium used for storing becomes large and time for checking if there is no overlap becomes long.

In view of the foregoing problems, an object of this invention is to give identification numbers which do not overlap each other and are hard to guess from the previous and next identification numbers, give identification numbers by a simple program, or rapidly generate identification numbers without using a memory medium having large capacitance.

According to one structure of this invention, an element (cipher text) of a ciphertext space which is one of components of the ciphertext space is calculated from an element (plaintext) of a plaintext space which is one of components of the plaintext space by encryption with a set of integers without overlap as the plaintext space, so that the element of the ciphertext space is used as an identification number. Note that as a method of the encryption, an encryption method of bijective mapping from a plaintext space to a ciphertext space is employed. As the encryption, for example, RSA cryptosystem, ElGamal cryptosystem, or the like can be employed.

In specific, a set of integers without overlap is stored in a memory medium, the set stored in the memory medium is read out, and encryption by bijective mapping from a plaintext space to a ciphertext space is performed by using the set read out as the plaintext space, so that an element (ciphertext) of the ciphertext space obtained from an element (plaintext) of the plaintext space is calculated and the element of the ciphertext space calculated is stored in a memory medium as an identification number.

In addition, a numbering device which gives an identification number by using the above-described method is also one structure of this invention. In specific, the numbering device includes a central processing unit, a numbering portion for numbering by using the above-described method in accordance with a command from the central processing unit, a memory medium for storing a set of integers, identification numbers, or the like without overlap, and an interface portion for outputting the stored identification numbers.

In addition, a laser direct drawing apparatus including the above-described numbering device is also one structure of this invention. In specific, a laser direct drawing device includes the above-described numbering device, a layout data formation device for forming layout data of a mask by combining an identification number output from the numbering device and coordinate data of the mask, a laser irradiation central processing unit, a laser oscillation device for oscillating laser light in accordance with a command from the laser irradiation central processing unit, an optical system for condensing the laser light, a stage on which an object to be processed is placed, and a stage controller for controlling the position of the stage in accordance with the command from the laser irradiation central processing unit such that the laser light condensed by the optical system scans a predetermined position of the stage in accordance with the layout data.

With this invention, at least one of giving identification numbers which do not overlap each other and are hard to guess from the previous and next identification numbers, giving identification numbers by a simple program, and rapidly generating identification numbers without using a memory medium having large capacitance is possible.

### BRIEF DESCRIPTION OF THE DRAWINGS

In the accompanying drawings:

FIG. 1 is a block diagram illustrating a structural example of a numbering device;

FIG. 2 is a block diagram illustrating a structural example of a layout data formation device;

FIG. 3 is a block diagram illustrating a structural example of a laser direct drawing apparatus; and

FIG. 4 is an example of a flow chart illustrating a process flow performed by the numbering device.

### DETAILED DESCRIPTION OF THE INVENTION

Embodiments of this invention disclosed hereinafter will be described with reference to drawings. However, it is easily understood by those skilled in the art that the invention disclosed is not limited to the embodiments below and can be implemented with a variety of different forms, and embodiments and details can be variously changed without departing from the scope and spirit of this invention. Therefore, this invention is not interpreted as being limited to the description of the embodiments below.

### Embodiment 1

In this embodiment, a numbering method using RSA cryptosystem will be described.

In the numbering method using RSA encryption, a private key and a public key are generated. First, a prime number p and a prime number q are determined. Then, using the prime numbers p and q, n=p×q and Euler's totient function φ(n)=(p−1)×(q−1) are solved. In addition, an integer e which is coprime to φ(n) and more than 1 and less than φ(n) is determined. Then, an inverse d of e modulo φ(n) is found. That is, d which satisfies de≡1 (mod φ(n)) is found. The above described p, q, and d are private keys and n and e are public keys.

Next, a set of integers of 0 or more and less than n is set to be a plaintext space and encryption thereof is performed. When an integer x (0≦x<n) is an element (plaintext) of the plaintext space, a remainder y (note that 0≦y<n) of x^{e} modulo n is an element (ciphertext) of a ciphertext space. That is, when y which satisfies y≡x^{e} (mod n) and 0≦y<n is solved, this y is the ciphertext which corresponds to the plaintext x.

Note that a reminder z (note that 0≦z<n) of y^{d} modulo n is an element (decipher text) of a deciphertext space. That is, when z which satisfies z≡y^{d} (mod n) and 0≦z<n is found, this z is the deciphertext which corresponds to the ciphertext y (x=z).

Next, the numbering method of this invention, which employs RSA cryptosystem will be described by plugging a specific example of numeric value.

First, a private key and a public key are generated in accordance with the above-described procedure. Here, the prime number p is 2 and the prime number q is 17.

Then, according to the prime numbers p and q, n=p×q=34 and φ(n)=16 can be solved.

In addition, the integer e which is coprime to φ(n) and more than 1 and less than φ(n) is determined. Here, e is set at 3.

Then, the inverse d of e modulo φ(n) is found. That is, d which satisfies de≡1 (mod φ(n)) is found. Here, d set at 11.

Accordingly, p=2, q=17, and d=11 are private keys and n=34 and e=3 are public keys.

Next, a set of integers of 0 or more and less than n is set to be a plaintext space and encryption thereof is performed. When x (0≦x<n) is an element (plaintext) of the plaintext space, a remainder y (note that 0≦y<34) of x^{e} modulo n is an element (ciphertext) y of a ciphertext space. That is, when y which satisfies y≡x^{e} (mod n) and 0≦y<34 is found, this y is the ciphertext which corresponds to the plaintext x.

Note that a reminder z (note that 0≦z<34) of y^{d} modulo n is an element (deciphertext) of a deciphertext space. That is, when z which satisfies z≡y^{d} (mod n) and 0≦z<34 is found, this z is the deciphertext which corresponds to the ciphertext y (x=z).

In Table 1 below, specific numeric values of the ciphertext y and the decipher text z with respect to the plaintext x, which are obtained from the above calculation, are shown.

TABLE 1

| x | y | z |
|---|---|---|
| 0 | 0 | 0 |
| 1 | 1 | 1 |
| 2 | 8 | 2 |
| 3 | 27 | 3 |
| 4 | 30 | 4 |
| 5 | 23 | 5 |
| 6 | 12 | 6 |
| 7 | 3 | 7 |
| 8 | 2 | 8 |
| 9 | 15 | 9 |
| 10 | 14 | 10 |
| 11 | 5 | 11 |
| 12 | 28 | 12 |
| 13 | 21 | 13 |
| 14 | 24 | 14 |
| 15 | 9 | 15 |
| 16 | 16 | 16 |
| 17 | 17 | 17 |
| 18 | 18 | 18 |
| 19 | 25 | 19 |
| 20 | 10 | 20 |
| 21 | 13 | 21 |
| 22 | 6 | 22 |
| 23 | 29 | 23 |
| 24 | 20 | 24 |
| 25 | 19 | 25 |
| 26 | 32 | 26 |
| 27 | 31 | 27 |
| 28 | 22 | 28 |
| 29 | 11 | 29 |
| 30 | 4 | 30 |
| 31 | 7 | 31 |
| 32 | 26 | 32 |
| 33 | 33 | 33 |

As shown in Table 1, mapping from a plaintext space to a ciphertext space and mapping from the ciphertext space to a deciphertext space are bijective, and the plaintext x is equal to the decipher text z. Since there is no overlap in the plaintexts and mapping from the plaintext space to the ciphertext space is bijective, the ciphertexts do not overlap each other. Moreover, when the plaintexts are arranged in numeric sequence, the ciphertexts corresponding thereto are arranged in an order whose regularity is hard to guess.

Thus, by giving the ciphertext y as an identification number, even when a memory medium with large capacitance is not used, identification numbers of integers of 0 or more and less than n can be rapidly generated so as to have an order which is hard to guess and not to overlap each other.

Note that in this embodiment, in order to make clear that mapping from the plaintext space to the ciphertext space is bijective, the case where n is small is described; however, when n is set to be large by making each of p and q large, the ciphertext y which can be used as a practical identification number can be obtained.

In addition, although n and e are the public keys, if an identification number is obtained by actually using RSA cryptosystem, n and e are not made public.

In addition, when a letter such as an alphabet is used as an identification number, the numeric value of the ciphertext y may be converted to a letter in accordance with a character code or the like.

By giving an identification number by using the RSA cryptosystem described in this embodiment, an identification number which is hard to guess from the previous and next identification numbers can be given. In addition, since identification numbers generated do not overlap, a program for checking whether the generated identification number overlaps identification numbers previously generated is not necessary. That is, identification numbers can be given by a simple program. Further, identification numbers can be rapidly generated without using a memory medium having large capacitance.

### Embodiment 2

In this embodiment, a numbering method using ElGamal cryptosystem will be described.

In the numbering method using ElGamal cryptosystem, a private key and a public key are generated. First, a prime number p is determined. Then, y is found by calculation of a primitive root g modulo p, a random number x of (p−1) or less (note that 0<x), and y≡g^{x} (mod p) (note that 0<y<p). The above-described p, g, and y are public keys and x is a private key.

Next, encryption is performed by using the public keys (p, g, y). Here, an integer m (note that 0≦m<p) is set to be an element (plaintext) of a plaintext space. First, a random number r (note that 0<r) of (p−1) or less is generated. Then, (c₁, c₂) which satisfy Formula 1 and Formula 2 below with respect to the plaintext m is found, so that (c₁, c₂) are used as ciphertexts.

c₁≡g^{r}(mod p) (note that 0≦c₁<p) (Formula 1)

c₂≡my^{r}(mod p) (note that 0≦c₂<p) (Formula 2)

Note that finding d which satisfies d≡(c₂/c₁^{x}) (mod p) (note that 0≦d<p) by using the private key x, this d is used as a deciphertext (m=d).

Next, the numbering method of this invention using ElGamal cryptosystem will be described by plugging specific numeric values.

In accordance with the above-described procedure, a private key and public keys are generated first. Here, the prime number p is 31, the primitive root g modulo p is 21, and the random number x of (p−1) or less is 4. When y which satisfies y≡g^{x} (mod p) (note that 0<y<p) is found in accordance with the numeric values above, y is 18. In this manner, the public keys (p, g, y) are (31, 21, 18) and the private key x is 4.

In addition, the random number r of (p−1) or less is 14. In this manner, c₁ which satisfies c₁=g^{r} (mod p) (note that 0≦c₁<p) is found, whereby the ciphertext c₁ is 28.

The values of the ciphertext c₂=my^{r} (mod p) and d=(c₂/c₁^{x}) (mod p) with respect to the plaintext m (an integer of 0≦m<p) to which the above-described values are plugged are shown in Table 2 below.

TABLE 2

| m | c₂ | d |
|---|---|---|
| 0 | 0 | 0 |
| 1 | 19 | 1 |
| 2 | 7 | 2 |
| 3 | 26 | 3 |
| 4 | 14 | 4 |
| 5 | 2 | 5 |
| 6 | 21 | 6 |
| 7 | 9 | 7 |
| 8 | 28 | 8 |
| 9 | 16 | 9 |
| 10 | 4 | 10 |
| 11 | 23 | 11 |
| 12 | 11 | 12 |
| 13 | 30 | 13 |
| 14 | 18 | 14 |
| 15 | 6 | 15 |
| 16 | 25 | 16 |
| 17 | 13 | 17 |
| 18 | 1 | 18 |
| 19 | 20 | 19 |
| 20 | 8 | 20 |
| 21 | 27 | 21 |
| 22 | 15 | 22 |
| 23 | 3 | 23 |
| 24 | 22 | 24 |
| 25 | 10 | 25 |
| 26 | 29 | 26 |
| 27 | 17 | 27 |
| 28 | 5 | 28 |
| 29 | 24 | 29 |
| 30 | 12 | 30 |

As shown in Table 2, mapping from a plaintext space to a ciphertext space and mapping from the ciphertext space to a deciphertext space are bijective, and the plaintext m is equal to the deciphertext d. Since there is no overlap in the plaintexts and mapping from the plaintext space to the ciphertext space is bijective, the ciphertexts do not overlap each other. Moreover, when the plaintexts are arranged in numeric sequence, the ciphertexts corresponding thereto are arranged in an order whose regularity is hard to guess.

Thus, by giving the ciphertext c₂ as an identification number, even when a memory medium with large capacitance is not used, identification numbers of integers of 0 or more and less than p can be rapidly generated so as to have an order which is hard to guess and not to overlap each other.

Note that in this embodiment, in order to make clear that mapping from the plaintext space to the ciphertext space is bijective, the case where p is small is described; however, when p is set to be large, the ciphertext c₂ which can be used as a practical identification number can be obtained.

In addition, although p, g, and y are the public keys, if an identification number is obtained by actually using ElGamal cryptosystem, p, g, and y are not made public.

In addition, when a letter such as an alphabet is used as an identification number, the numeric value of c₂ may be converted to a letter in accordance with a character code or the like.

By giving an identification number by using the ElGamal cryptosystem described in this embodiment, an identification number which is hard to guess from the previous and next identification numbers can be given. In addition, since identification numbers generated do not overlap, a program for checking whether the generated identification numbers overlap identification numbers previously generated is not necessary. That is, identification numbers can be given by a simple program. Further, identification numbers can be rapidly generated without using a memory medium having large capacitance.

### Embodiment 3

In this embodiment, a numbering device which gives an identification number by using a numbering method of this invention, and the structure of a laser direct drawing apparatus which writes data of the given identification number to a mask ROM will be described. Note that in this embodiment, as the numbering method, an example using the RSA cryptosystem described in Embodiment 1 will be described.

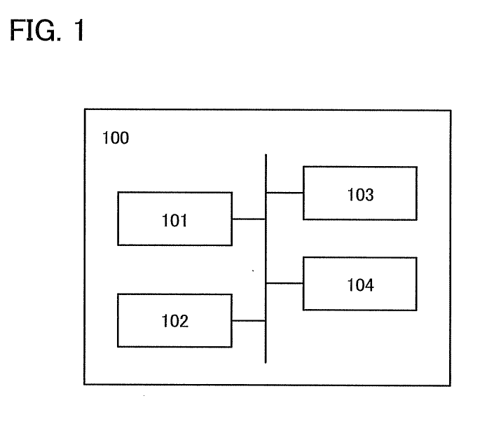

FIG. 1 is a block diagram of a structural example of a numbering device 100 of this invention. The numbering device 100 includes a central processing unit (CPU) 101, a memory medium 102, an interface portion 103, and a numbering portion 104. The central processing unit (CPU) 101 controls the operation of each of the memory media 102, the interface portion 103, and the numbering portion 104 included in the numbering device 100. The memory medium 102 includes a random access memory (RAM), a read only memory (ROM), a non-volatile memory, or the like. The interface portion 103 transmits/receives data to/from another device. The numbering portion 104 gives an identification number by an arithmetic process using the numbering method of this invention.

Note that the memory medium 102 can store various data such as a program executed by the central processing unit (CPU) 101 and the identification number given by the numbering portion 104. Moreover, the memory medium 102 also functions as a work area of the numbering portion 104 and can temporally store a calculation result and the like of the numbering portion 104.

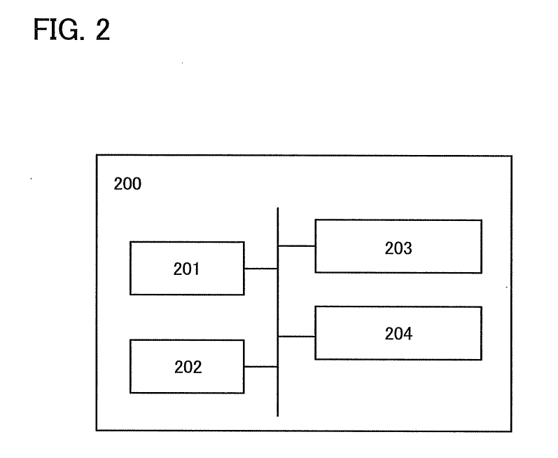

Next, FIG. 2 is a block diagram of a structural example of a layout data formation device 200. The layout data formation device 200 includes a central processing unit (CPU) 201, a memory medium 202, an interface portion 203, and a layout data formation portion 204. The central processing unit (CPU) 201 controls the operation of each of the memory medium 202, the interface portion 203, and the layout data formation portion 204 included in the layout data formation device 200. The memory medium 202 includes a RAM, a ROM, a non-volatile memory, or the like. The interface portion 203 transmits/receives data to/from another device. The layout data formation portion 204 forms layout data which is to be used for laser irradiation.

Note that the memory medium 202 can store various data such as a program executed by the central processing unit (CPU) 201 and layout data formed in the layout data formation portion 204. Moreover, the memory medium 202 also functions as a work area of the layout data formation portion 204 and can temporally store a calculation result and the like of the layout data formation portion 204.

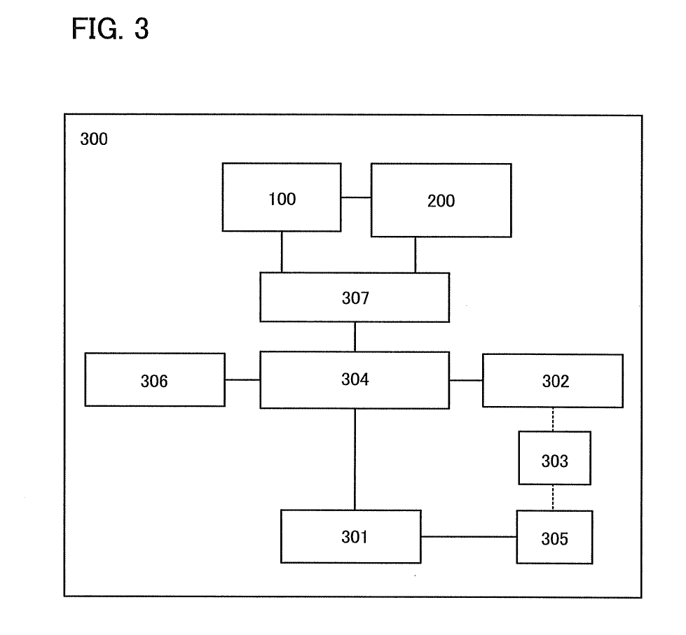

Next, FIG. 3 is a block diagram of a structural example of a laser direct drawing apparatus 300 including the numbering device of this invention. The laser direct drawing apparatus 300 includes the numbering device 100, the layout data formation device 200, a stage controller 301 which controls a position which is to be irradiated with a laser light, a laser oscillation device 302 which oscillates a laser light, an optical system 300 which condenses a laser light, a laser irradiation CPU 304, a stage 305 for placing an object to be processed, a memory medium 306, and an interface portion 307.

The laser irradiation CPU 304 controls oscillation of the layer oscillation device 302. Following a command of the laser irradiation CPU 304, the stage controller. 301 controls the position of the stage 305 such that a beam spot of a laser light condensed by the optical system 303 scans a predetermined position of the stage 305 in accordance with layout data transmitted from the layout data formation device 200.

Note that the memory medium 306 can store various data such as a program executed by the laser irradiation central processing unit (CPU) 304 and layout data for laser irradiation.

Note that although FIG. 1 illustrates the case where the numbering device 100, the layout data formation device 200, and the laser direct drawing apparatus 300 include the central processing unit (CPU) 101, the central processing unit (CPU) 201, and the laser irradiation CPU 304, respectively, the laser direct drawing apparatus 300 of this invention is not limited thereto. For example, a structure in which the numbering device 100 and the layout data formation device 200 do not include CPUs and the laser irradiation CPU 304 controls the numbering device 100 and the layout data formation device 200 is possible.

A process of the numbering device 100, which gives an identification number by using the numbering method of this invention, will be described below.

In order to make the numbering device 100 give an identification number, initializing operation is required in advance. In the initializing operation, numeric values which are required for giving an identification number shown in Table 3 are determined. In addition, among the numeric values shown in Table 3, n, e, and x₀ are stored in the memory medium 102.

TABLE 3

| | |
|---|---|
| p | Prime number |
| q | Prime number |
| n | p × q |
| φ(n) | (p − 1) × (q − 1) |
| e | Integer which is coprime to φ(n) and 1 < e < φ(n) |
| x₀ | Initial value (0 ≦ x₀ < n) |

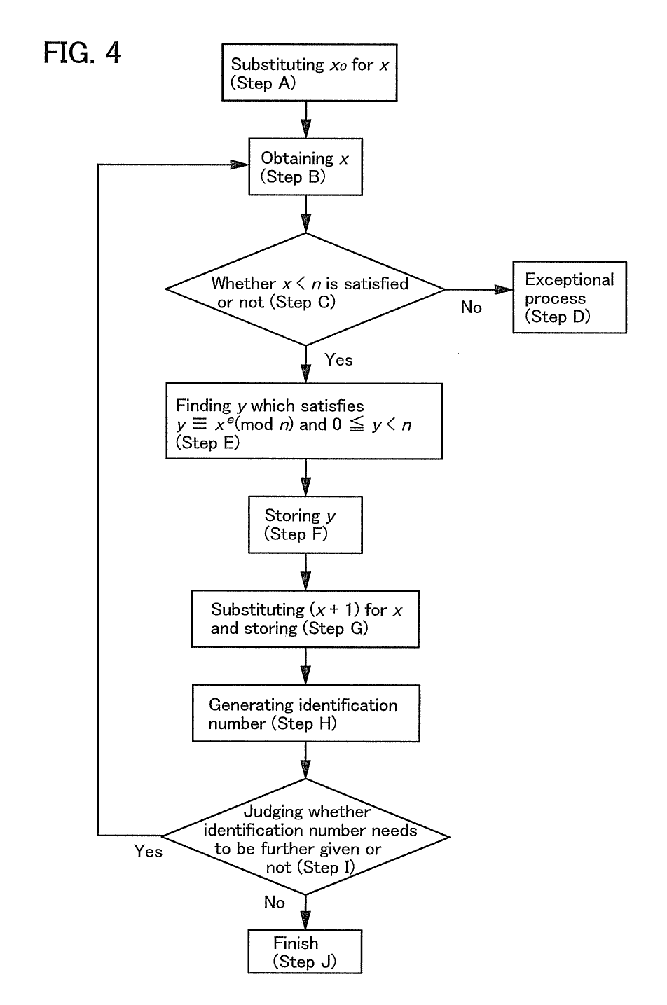

Next, a process of giving an identification number by the numbering device 100 after the initializing operation has been done will be described with reference to a flow chart of FIG. 4.

As shown in FIG. 4, first, the numbering portion 104 gets a data area of x in the memory medium 102, and then x₀ is substituted for x (Step A). Next, the numbering portion 104 obtains the value of x stored in the memory medium 102 (Step B). Next, whether the condition x<n is satisfied or not is judged (Step C). If the condition is not satisfied, an exceptional process is performed and numbering is not performed (Step D).

In the case where the condition is satisfied in Step C, y which satisfies y≡x^{e} (mod n) and 0≦y<n is found (Step E). Next, y found in Step E is stored in the memory medium 102 in order to use y as an identification number later (Step F). Next, (x+1) is substituted for x and is stored in the memory medium 102 (Step G). Next, an identification number is generated by combination of y found in Step E and data such as a product number (Step H). Next, whether an identification number needs to be further given or not is judged (Step I). If an identification number does not need to be further given, the process is finished (Step J). If an identification number needs to be further given, the process goes back to Step B and the same process is repeated.

Through such procedure described above, the numbering device 100 gives an identification number. In this manner, by storing n, e, and x₀ in the memory medium 102, identification numbers without overlap can be given.

Hereinafter, a process from giving an identification number by the numbering device 100 to laser irradiation on a mask ROM region of an object to be processed by the laser direct drawing apparatus 300 will be described.

First, the numbering device 100 transmits the given identification number to the layout data formation device 200. Then, the layout data formation device 200 combines the received identification number and coordinate data of a mask to be used for forming a mask ROM and forms layout data on which the given identification number is reflected. Next, the layout data formation device 200 transmits the formed layout data to the interface portion 307. Then, the laser irradiation CPU 304 stores the received layout data of the interface portion 307 in the memory medium 306. Next, the laser irradiation CPU 304 controls the stage controller 301 and the laser oscillation device 302 in accordance with the layout data stored in the memory medium 306 and performs laser irradiation on the mask ROM region of the object to be processed.

With writing of an identification number in the mask ROM region of the object to be processed by using the numbering device and the laser direct drawing apparatus of this embodiment, the processed object can have an identification number which has no overlap and is hard to guess. Further, since the numbering device of this embodiment does not make overlap in identification numbers to give, a program for checking overlap between an identification number given and an identification number/identification numbers previously generated is not required. In other words, an identification number can be given by a simple program. Further, the numbering device of this embodiment does not need a memory medium having large capacitance and can rapidly give identification numbers without overlap by storing a small amount of numeric values in a memory medium.

This embodiment can be implemented by combination of the above embodiments as appropriate.

This application is based on Japanese Patent Application serial no. 2008-072632 filed with Japan Patent Office on Mar. 20, 2008, the entire contents of which are hereby incorporated by reference.

What is claimed is:

1. A numbering method comprising:
storing a set of integers without overlap in a memory medium;
reading out the set stored in the memory medium;
using the set read out as a plaintext space and performing encryption in which mapping from the plaintext space to a ciphertext space is bijective, thereby obtaining an element of the ciphertext space from an element of the plaintext space; and
storing the element of the ciphertext space calculated in the memory medium as an identification number.

2. The method according to claim 1, wherein the method further comprises writing the identification number in a mask ROM region of an object to be processed.

3. A numbering method comprising:
storing a set of integers without overlap in a memory medium;
reading out the set stored in the memory medium;
using the set read out as a plaintext space and performing encryption thereof by RSA cryptosystem, thereby obtaining an element of the ciphertext space from an element of the plaintext space; and
storing the element of the ciphertext space calculated in the memory medium as an identification number.

4. The method according to claim 3, wherein the method further comprises writing the identification number in a mask ROM region of an object to be processed.

5. A numbering method comprising:
storing a set of integers without overlap in a memory medium;
reading out the set stored in the memory medium;
using the set read out as a plaintext space and performing encryption thereof by ElGamal cryptosystem, thereby obtaining an element of the ciphertext space from an element of the plaintext space; and
storing the element of the ciphertext space calculated in the memory medium as an identification number.

6. The method according to claim 5, wherein the method further comprises writing the identification number in a mask ROM region of an object to be processed.

7. A numbering device comprising:
a central processing unit;
a numbering portion configured to give an identification number in accordance with a command from the central processing unit by using a set of integers without overlap as a plaintext space and performing encryption in which mapping from the plaintext space to a ciphertext space is bijective;
a memory medium configured to store the identification number; and
an interface portion configured to output the identification number stored in the memory medium.

8. A laser direct drawing apparatus comprising:
a numbering device, the numbering device comprising:
a central processing unit;
a numbering portion configured to give an identification number in accordance with a command from the central processing unit by using a set of integers without overlap as a plaintext space and performing encryption in which mapping from the plaintext space to a ciphertext space is bijective;
a memory medium configured to store the identification number; and
an interface portion configured to output the identification number stored in the memory medium,
a layout data formation device configured to form a layout data of a mask by combining the identification number output from the numbering device and a coordinate data of the mask;
a laser irradiation central processing unit;
a laser oscillation device configured to oscillate a laser light in accordance with a command from the laser irradiation central processing unit;
an optical system configured to condense the laser light;
a stage on which an object to be processed is placed; and
a stage controller configured to control the position of the stage in accordance with the command from the laser irradiation central processing unit such that the laser light condensed by the optical system scans the stage in accordance with the layout data.
